(19) United States
(12) Patent Application Publication
(10) Pub. No.: US 2026/0281274 A1
(43) Pub. Date: Sep. 17, 2026

(54) STORAGE MEDIUM, CONTROL METHOD, AND INFORMATION PROCESSING APPARATUS FOR CONFIGURING FAX COVER SHEET SETTINGS

(71) Applicant: CANON KABUSHIKI KAISHA, Tokyo (JP)

(72) Inventor: YUKI DAIKU, Chiba (JP)

(21) Appl. No.: 19/532,229

(22) Filed: Feb. 6, 2026

(30) Foreign Application Priority Data
Mar. 17, 2025 (JP) 2025-042476

(51) Int. Cl. H04N 1/32; G06F 40/186; H04N 1/00

(52) U.S. Cl. CPC H04N 1/32133; G06F 40/186; H04N 1/0048; H04N 1/00482; H04N 2201/0093; H04N 2201/0094; H04N 2201/3273; H04N 2201/3274; H04N 2201/3278

(57) ABSTRACT

A non-transitory computer-readable storage medium stores a computer program that supports a standard driver provided by a provider of an operating system. The computer program is configured to cause a computer to display a settings reception screen that includes a template selection section. The template selection section is configured to receive a selection of a template related to a cover sheet to be attached to image data output from the standard driver.

### CROSS-REFERENCE TO RELATED APPLICATION

This application claims the benefit of Japanese Patent Application No. 2025-042476, filed Mar. 17, 2025, which is hereby incorporated by reference herein in its entirety.

### BACKGROUND

### Field of the Technology

The present disclosure relates to a storage medium, a control method, and an information processing apparatus.

### Description of the Related Art

In recent years, Windows (registered trademark) has provided a standardized class driver (hereinafter sometimes referred to as a “standard driver”) that can be commonly used even with image forming apparatuses having a print function that are supplied by a plurality of different vendors. Such a standard driver is preinstalled in the operating system (OS). The standard driver can be used by connecting an arbitrary image forming apparatus to a host computer having an OS in which the standard driver is incorporated. Accordingly, it is unnecessary to install a printer driver specific to the individual model. The standard driver can also be used by specifying print functions of the image forming apparatus in accordance with Print Device Capabilities (PDC), which are generated based on information acquired from the image forming apparatus. As a result, print functions can be specified for each image forming apparatus through a single standard driver. A function extension application (hereinafter sometimes referred to as an “extension application”) for extending functions can be associated with the standard driver. The extension application is provided by each vendor. Therefore, it is difficult to implement the functions of the extension application using only the standard driver.

Japanese Patent Application Laid-Open No. 2023-080177 discloses a computer program that causes an information processing apparatus connected to an image forming apparatus to display an input screen (fax settings UI) used to enter destination information required for fax transmission from the image forming apparatus.

In the conventional technology mentioned above, the displayed fax settings UI is composed only of setting items for standard fax functions. This is the case even when the image forming apparatus connected to the information processing apparatus is equipped with, in addition to the standard fax functions, manufacturer-specific fax functions.

Meanwhile, in fax transmission, it is customary to attach a cover sheet to the beginning of the document to be transmitted. The standard fax functions do not allow settings related to such a cover sheet to be configured.

### SUMMARY

Embodiments described herein are directed to technology for configuring settings related to a cover sheet in implementing a fax function in an image processing apparatus.

In one embodiment, a non-transitory computer-readable storage medium stores a computer program that supports a standard driver provided by a provider of an operating system. The computer program is configured to cause a computer to display a settings reception screen that includes a template selection section. The template selection section is configured to receive a selection of a template related to a cover sheet to be attached to image data output from the standard driver.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a printing system according to a first embodiment.

FIGS. 2A and 2B are block diagrams illustrating a software configuration of the printing system.

FIGS. 3A-3H are diagrams each illustrating an example of a screen displayed on a display of a host computer when a printer has a fax transmission function.

FIG. 3I is a diagram illustrating an example of items included in a cover sheet.

FIG. 4 is a flowchart illustrating a process in which a print function extension unit edits print function information.

FIG. 5 is a diagram illustrating an example of a list of capability information of the printer.

FIG. 6 is a diagram illustrating an example of a list of functions supported by an extension application.

FIG. 7 is a diagram illustrating an example of a list of capability information of general-purpose printing software.

FIG. 8 is a sequence diagram illustrating a process performed among a rendering application, the general-purpose printing software, the extension application, and the printer after the rendering application receives fax settings.

FIGS. 9A and 9B are diagrams each illustrating an example of a screen displayed on the display of the host computer when the printer does not include a fax transmission function.

FIG. 10 is a flowchart illustrating in detail a fax transmission processing flow of an intermediate data editing unit according to the first embodiment.

FIGS. 11A and 11B are diagrams illustrating examples of a list of capability information generated by an extension application according to a second embodiment.

FIGS. 12A and 12B are diagrams each illustrating an example of a screen displayed on a display of a host computer when a printer has a fax transmission function according to the second embodiment.

FIG. 13 is a sequence diagram illustrating a process performed between the extension application and the printer according to the second embodiment.

FIGS. 14A to 14D are screen diagrams for entering content into a cover sheet according to a third embodiment.

FIG. 15 is a sequence diagram illustrating a process performed between an extension application and a printer according to the third embodiment.

FIG. 16 is a flowchart illustrating a process for entering a destination according to the third embodiment.

FIGS. 17A and 17B are screen diagrams for editing a cover sheet template according to a fourth embodiment.

FIG. 18 is a sequence diagram illustrating a process flow for editing and storing a template among an extension application, a printer, and a storage device according to the fourth embodiment.

### DESCRIPTION OF THE EMBODIMENTS

Example embodiments will be described in detail with reference to the accompanying drawings. It should be noted that the following embodiments are provided for illustrative purposes only and are not intended to limit the scope of the disclosure. While multiple features are described in the embodiments, the disclosure is not limited to embodiments that incorporate all such features, and various combinations of these features may be contemplated as appropriate. Furthermore, in the drawings, like reference numerals designate like or corresponding components, and duplicative descriptions thereof are omitted to avoid redundancy.

### First Embodiment

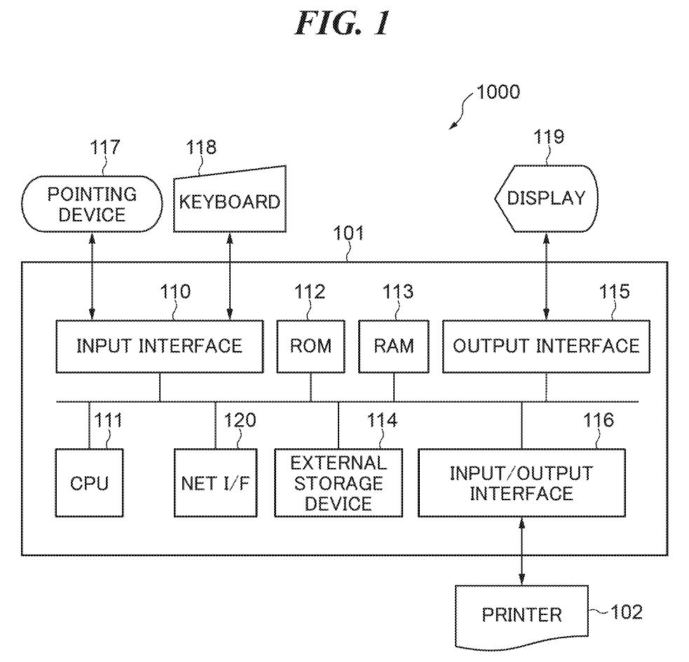

A first embodiment will be described below with reference to FIGS. 1-10.

### Hardware Configuration of the Printing System

FIG. 1 is a block diagram illustrating a hardware configuration of a printing system according to the first embodiment. As illustrated in FIG. 1, a printing system 1000 includes a host computer 101, a printer 102, a pointing device 117, a keyboard 118, and a display 119, which are communicatively connected to one another. The host computer 101 is an information processing apparatus and includes an input interface 110, a CPU 111, a ROM 112, a RAM 113, an external storage device 114, an output interface 115, an input/output interface 116, and a NET interface (I/F) 120. The host computer 101 may be, for example, a desktop personal computer; however, it is not limited thereto and may also be, for example, a notebook personal computer, a tablet device, a smartphone, or the like.

The CPU 111 is a processor that executes computer programs and the like stored in the ROM 112 and the external storage device 114. Accordingly, the CPU 111 can implement respective steps (control method) described later. The ROM 112 stores an initialization program. The external storage device 114 stores application programs, an operating system (OS), print data generation software, and various other data. In the present embodiment, Windows® 11 by Microsoft® is installed on the host computer 101 as the OS. The RAM 113 is used as a work memory or the like to execute various programs stored in the external storage device 114, thereby enabling the various programs to operate on the host computer 101. The pointing device 117 and the keyboard 118, which serve as input devices, are connected to the input interface 110. The display 119, which serves as a display device, is connected to the output interface 115. The display 119 displays, for example, a print settings screen and an advanced settings screen described later. The NET interface 120 is a network interface that performs control for transferring data to and from external devices via a network. The printer 102 is connected to the input/output interface 116. As a result, the host computer 101 is capable of communicating with printers 102 regardless of their manufacturer. In other words, the host computer 101 can process information exchanged with printers 102 from different manufacturers.

As the printer 102, an image forming apparatus (image processing apparatus) such as a multifunction peripheral (MFP) having a plurality of functions including copying, printing, and faxing may be used, although the printer 102 is not limited thereto. In the present embodiment, printing performed by the printer 102 is assumed to be electrophotographic printing; however, it is not limited thereto and may be, for example, inkjet printing or the like. In addition, although the host computer 101 and the printer 102 are configured as separate devices in the present embodiment, they are not limited to this configuration. For example, the host computer 101 and the printer 102 may be integrated as a single device.

### Software-Centric Configuration of the Printing System

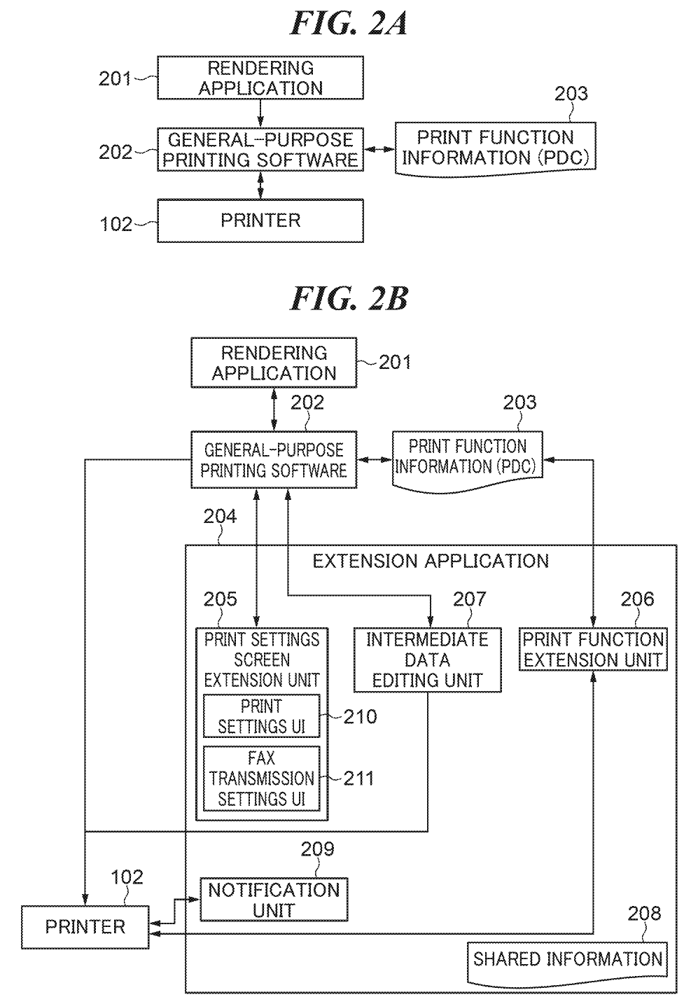

FIGS. 2A and 2B are block diagrams illustrating a software configuration of the printing system. FIG. 2A illustrates a general configuration in which an extension application (application program) 204 is not associated with general-purpose printing software (standard driver) 202 and the printer 102. FIG. 2B illustrates a configuration in which the extension application 204 is associated with the general-purpose printing software 202 and the printer 102. The general-purpose printing software 202 is a standard driver provided by the provider of the OS. The standard driver is a class driver (general-purpose program) that can be commonly used, for example, during printing, for printers (printer 102) from a plurality of manufacturers. The standard driver is preinstalled (incorporated) in the OS; that is, it is provided as one of the functions included in the OS package. The standard driver can perform processing for various printers by using a standardized printing method. Accordingly, the standard driver can generate and output instructions that can be interpreted by printers from different manufacturers. As the general-purpose printing software 202, a computer program that operates based on the Internet Printing Protocol (IPP) may be used. The extension application 204 is a computer program that supports or supplements the general-purpose printing software 202. In the present embodiment, the extension application 204 is an extension program (a computer program that implements a control method) capable of providing functions that cannot be performed on the printer 102 by the general-purpose printing software 202; however, it is not limited thereto. For example, the extension application 204 may be a computer program that improves the usability of functions that can be performed on the printer 102 by the general-purpose printing software 202. The extension application 204 is stored, for example, in the external storage device 114 together with the OS (general-purpose printing software 202). As a result, the host computer 101 includes the general-purpose printing software 202 and the extension application 204.

### Case Where the Extension Application 204 is Not Associated

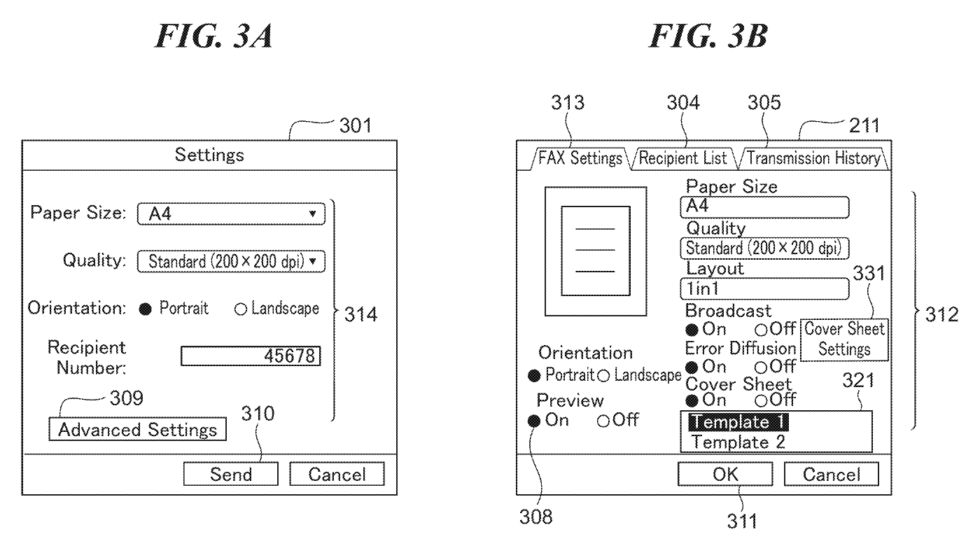

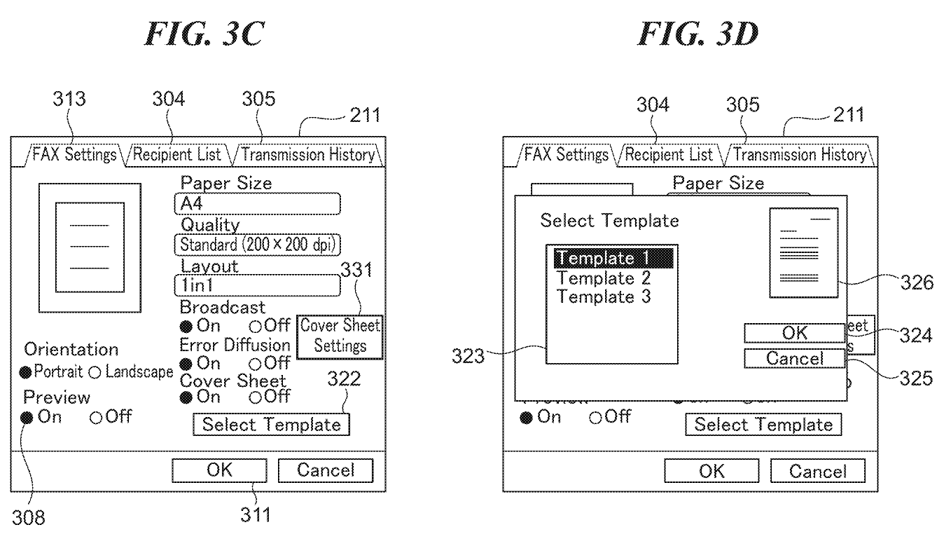

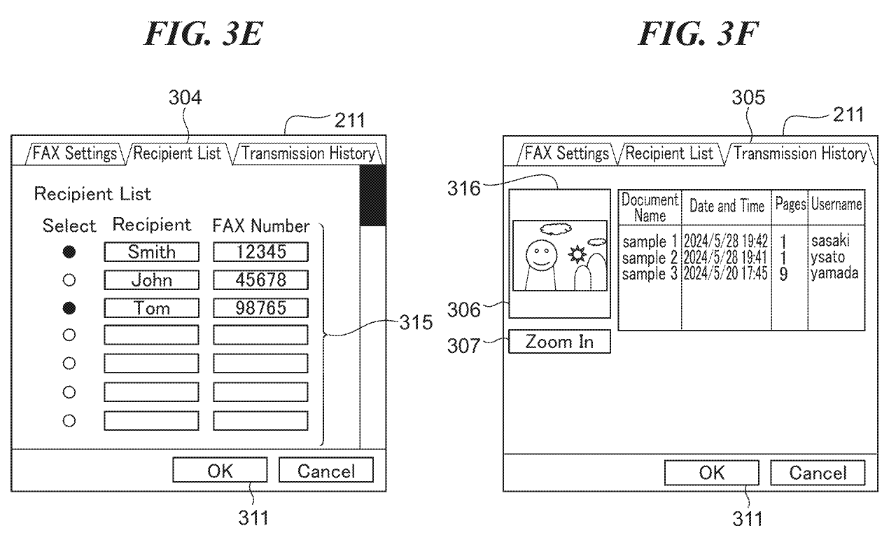

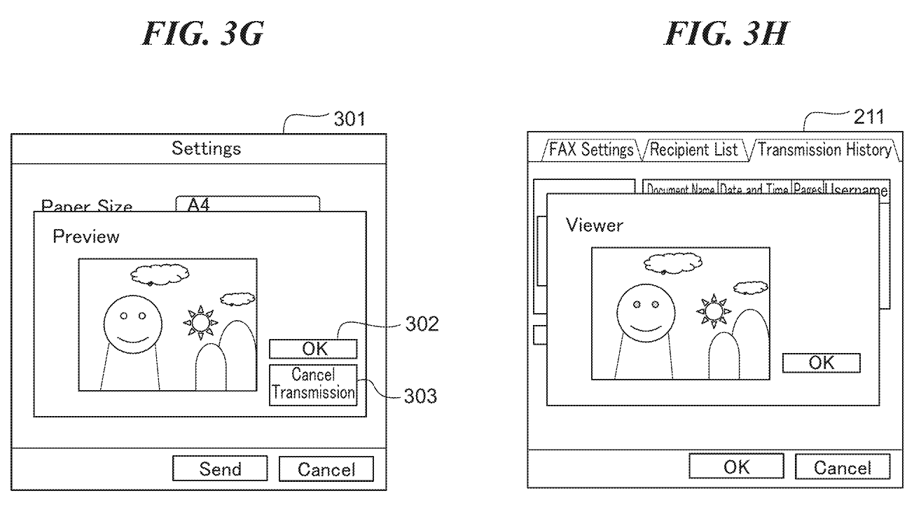

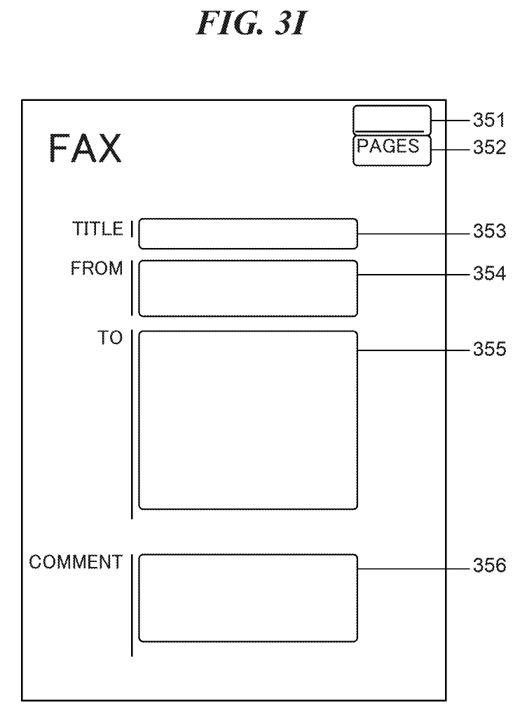

First, with reference to FIG. 2A, a configuration will be described in which the extension application 204 is not associated with the general-purpose printing software 202 and the printer 102. A rendering application 201 is software used to create content (print data) to be printed by the printer 102. The rendering application 201 is not particularly limited and may be, for example, a word processing application, a spreadsheet application, or the like. The rendering application 201 issues a print instruction to the OS in response to, for example, a print request from a user through the keyboard 118. The print instruction includes print settings information for instructing the operation of the general-purpose printing software 202 and the printer 102. The print settings information is also referred to as a “Print Ticket (PT).” In order to output the print settings information, the rendering application 201 can cause a fax transmission settings UI 301 (see FIG. 3A), which is provided by any one of the general-purpose printing software 202, the OS, and the rendering application 201, to be displayed. In addition, when a button 309 on the fax transmission settings UI 301 is operated (pressed), a fax transmission settings UI 211 (see FIG. 3B) can be displayed on the display 119. The fax transmission settings UI 301 and the fax transmission settings UI 211 will be described later. A print settings screen includes setting items indicating print functions that can be set in accordance with capability information acquired from the general-purpose printing software 202, i.e., information indicating the print settings that can be configured, and control items that indicate the corresponding setting values. The capability information is information relating to the printing capability of the printer 102 and is also referred to as “Print Capabilities” (hereinafter sometimes abbreviated as “PC”). It is also possible to determine whether the capability information includes information that enables the display of the fax transmission settings UI 211 (determination step). If it is determined that the capability information includes information that enables the display of the fax transmission settings UI 211, the fax transmission settings UI 211 can be displayed. On the other hand, if it is determined that the capability information does not include information that enables the display of the fax transmission settings UI 211, the fax transmission settings UI 211 is not displayed. In this manner, the extension application 204 can switch whether or not to display the fax transmission settings UI 211 according to the capability information of the printer 102.

The general-purpose printing software 202 determines the capability information (PC) based on print function information 203. The print function information 203 is data indicating print functions, which describes all configurable print functions and their setting values, as well as any mutually exclusive relationships among the setting values. The print function information 203 is also referred to as Print Device Capabilities (PDC). The print function information 203 is included in a configuration file of the general-purpose printing software 202 and is stored in the external storage device 114 as a file that cannot be modified. Alternatively, the print function information 203 may be dynamically generated by the general-purpose printing software 202. Specifically, the general-purpose printing software 202 acquires attribute data of the printer 102 from the printer 102. The general-purpose printing software 202 then generates the print function information 203 in accordance with the attribute information contained in the attribute data. When dynamically generated in this manner, the print function information 203 can be edited. The attribute data of the printer 102 is obtained as a response by issuing an IPP “Get-Printer-Attributes” request to the printer 102. The response includes attribute information indicating the functions that can be specified on the printer 102, i.e., attribute information indicating the capabilities of the printer 102, and setting values related to the attribute information. The response is stored in the RAM 113.

With this configuration, the general-purpose printing software 202 allows the user to specify print functions that are available on the printer 102 according to the printer 102 connected to the general-purpose printing software 202. Accordingly, regardless of the type of printer 102 connected to the general-purpose printing software 202, it becomes possible to specify print functions available on the connected printer, even when a printer having different functions or a printer developed by a different printer manufacturer is connected. In the present embodiment, the general-purpose printing software 202 is configured to use the “IPP Class Driver” included in Windows® 11. The IPP Class Driver is a printer driver that performs printing processing in accordance with the specifications of a standard printing protocol called IPP and is bundled in the OS package. The IPP Class Driver is not a model-specific printer driver corresponding to the model of the printer 102, but rather a standard class driver that can be commonly used with various printers regardless of the printer manufacturers. The IPP Class Driver acquires capability information of the printer 102 and generates the print function information 203 based on the acquired information.

The general-purpose printing software 202 can also be associated with the extension application 204. This enables the general-purpose printing software 202 to perform functions that are not originally provided in the general-purpose printing software 202. For example, the general-purpose printing software 202 cannot perform the function of receiving a setting to perform both fax transmission of image data and printing based on the image data (hereinafter referred to as a “fax transmission with simultaneous printing setting”). This is because the fax transmission with simultaneous printing setting is a setting unique to printers 102 manufactured by a specific printer manufacturer. The extension application 204 can extend the functionality to enable a setting for selecting a template regarding a cover sheet to be attached to the image data, which the IPP Class Driver cannot perform. In the present embodiment, the general-purpose printing software 202 cannot perform the selection setting for a template regarding a cover sheet, and the extension application 204 can extend the functionality to enable the selection setting; however, the embodiment is not limited thereto. For example, the IPP Class Driver may be able to perform a portion of the selection setting for a template regarding a cover sheet, and the extension application 204 may supplement the remaining portion of the selection setting to further expand the functional scope. The template regarding the cover sheet will be described later.

The OS generates intermediate data (sometimes referred to as “input data”) based on a print instruction output from the rendering application 201 and transmits the intermediate data to the general-purpose printing software 202. The data output from the rendering application 201 for printing is not particularly limited and may be, for example, data in the XML Paper Specification (XPS) format. The data output from the rendering application 201 for printing may alternatively be data in the Graphic Device Interface (GDI) format. When the IPP Class Driver is used as the general-purpose printing software 202, if the data output from the rendering application 201 is in the GDI format, the OS converts the GDI format data into XPS format data. The OS then transmits the converted XPS format data to the general-purpose printing software 202 as the intermediate data. If the data output from the rendering application 201 is in the XPS format, the OS transmits the XPS format data as the intermediate data to the general-purpose printing software 202 without conversion. The intermediate data includes rendering data, which is information such as text and graphics to be formed on a printing medium, and print settings information set by the user.

The general-purpose printing software 202 converts the acquired intermediate data into two types of data that can be processed by the printer 102. In other words, the general-purpose printing software 202 generates two types of data that can be processed by the printer 102 based on the intermediate data. As a first type of data, transmission image data for performing fax transmission (hereinafter also referred to as “fax data”) is generated. As a second type of data, print image data for performing printing (hereinafter also referred to as “print data”) is generated. These two types of data are then transmitted to the printer 102. In the present embodiment, the “fax data” refers to data that is transmitted by the printer 102 to one or more fax destinations (recipients) set using the IPP protocol. The fax data includes one or more set destinations and generated cover sheet data.

On the other hand, the “print data” is Page Description Language (PDL) data compliant with IPP. The PDL data may be, for example, data in Portable Document Format (PDF) or PWG-Raster format. The print data includes rendering data, which is information such as text and graphics to be formed on a print sheet (printing medium), and print setting attribute information that is generated based on the print settings information set by the user and that specifies print settings. The print setting attribute information includes attribute information indicating functions that can be specified on the printer 102, i.e., attribute information indicating the capabilities of the printer 102, and setting values related to the attribute information.

The printer 102 performs fax transmission of the fax data received from the general-purpose printing software 202 to a predetermined fax destination. The printer 102 also performs printing on a print sheet based on the print data received from the general-purpose printing software 202. At this time, the printer 102 operates in accordance with the print setting attribute information included in the print data, thereby forming an image based on the rendering data included in the print data on the print sheet. The print setting attribute information includes, for example, attribute information for specifying print quality, such as quality priority or speed priority, and for specifying double-sided printing or single-sided printing, as well as setting values of the attribute information. For example, when the print setting attribute information includes attribute information specifying double-sided printing, the printer 102 can perform double-sided printing.

### Case Where the Extension Application 204 is Associated

With reference to FIG. 2B, a configuration will be described in which the extension application 204 is associated with the general-purpose printing software 202 and the printer 102. As illustrated in FIG. 2B, the extension application 204 is added to the configuration of FIG. 2A. In other words, the host computer 101 includes the rendering application 201, the general-purpose printing software 202, and the print function information 203, and further includes the extension application 204. The extension application 204 is software for extending the functions of the general-purpose printing software 202. Note that the extension application 204 is software that is not pre-installed in (i.e., not bundled with) the OS. Accordingly, the extension application 204 may be downloaded from a server (not illustrated) via the Internet and installed on the host computer 101 by the user operating the host computer 101. Alternatively, when the printer 102 is connected to the host computer 101, the extension application 204 may be automatically installed on the host computer 101 in response to this connection. Specifically, when the printer 102 is connected to the host computer 101, the OS acquires device identification information from the printer 102. The OS may then download the extension application 204 corresponding to the device identification information from a server via the Internet and install it on the host computer 101. As a result, the general-purpose printing software 202 and the extension application 204 are stored in the host computer 101 as mutually independent control programs. The general-purpose printing software 202 and the extension application 204 may each be updated to be upgraded in version. In such a case, the update processing of the general-purpose printing software 202 and the update processing of the extension application 204 may be performed at the same timing or at different timings. In addition, the trigger for the host computer 101 to acquire the general-purpose printing software 202 and the trigger for the host computer 101 to acquire the extension application 204 may be the same or may be different. When the extension application 204 is installed, the OS associates the extension application 204 with the general-purpose printing software 202 and the printer 102.

As illustrated in FIG. 2B, the extension application 204 is capable of exchanging information (i.e., transmitting and receiving information) with each of the general-purpose printing software 202 and the printer 102. In other words, the extension application 204 is associated with the general-purpose printing software 202 and the printer 102. In the present embodiment, the extension application 204 includes a print settings screen extension unit 205, a print function extension unit 206, an intermediate data editing unit 207, and a notification unit 209. The extension application 204 further includes shared information 208 that is accessible from each of the print settings screen extension unit 205, the print function extension unit 206, the intermediate data editing unit 207, and the notification unit 209. The shared information 208 is a file stored in the external storage device 114 or information stored in the RAM 113. The extension application 204 can write to or read from the shared information 208 by using an application program interface (API) provided by the OS.

The extension application 204 may terminate its overall operation upon completion of processing performed by each of the units from the print settings screen extension unit 205 to the notification unit 209. In this case, the OS launches the extension application 204 each time it receives a request to execute processing of any of the units. Additionally, for example, when the processing of the print settings screen extension unit 205 is completed, the OS may cause the extension application 204 to terminate its overall operation. The extension application 204 may also cancel the processing of any of the units from the print settings screen extension unit 205 to the notification unit 209 while the processing is being executed. In such a case, the job being processed in the print queue is deleted by the OS. As described above, the rendering application 201 issues a fax transmission instruction to the OS in response to a fax transmission request from the user. The rendering application 201 can also cause a print settings screen to be displayed similarly to the configuration of FIG. 2A. In the configuration illustrated in FIG. 2B, the rendering application 201 can cause the fax transmission settings UI 211 provided by the print settings screen extension unit 205 (the extension application 204) to be displayed. The print settings screen extension unit 205 can also store advanced settings specified by the user in the shared information 208.

The print settings screen extension unit 205 displays, on the display 119, a print settings UI (print settings screen) 210 for performing print settings and the fax transmission settings UI (fax transmission settings screen) 211 for performing fax transmission settings. The intermediate data editing unit 207 acquires intermediate data from the general-purpose printing software 202. The intermediate data editing unit 207 then converts the intermediate data into fax data and print data, and transmits the respective data to the printer 102. The intermediate data editing unit 207 also acquires advanced settings information from the shared information 208 and adds the advanced settings to the fax data and the print data. The printer 102 performs fax transmission to a predetermined destination based on the fax data received from the intermediate data editing unit 207. In addition, the printer 102 performs printing on a sheet based on the print data received from the intermediate data editing unit 207. The extension application 204 may alternatively be configured to acquire fax data and print data generated by the general-purpose printing software 202 and add the advanced settings to each of the acquired data. Even in the configuration illustrated in FIG. 2B, there may be cases where the fax transmission with simultaneous printing setting is not performed. In such cases, the general-purpose printing software 202 may transmit the fax data and the print data directly to the printer 102 without passing the data through the extension application 204.

The print function extension unit 206 is capable of editing the print function information 203 (PDC) generated by the general-purpose printing software 202 or the OS. This makes it possible to add functions provided by the extension application 204. It is also possible to add functions that can be performed by the printer 102 but cannot be performed by the general-purpose printing software 202 (for example, a line-width adjustment function), to add mutually exclusive relationships among setting values of print functions, and the like. The OS activates the print function extension unit 206 when the extension application 204 is initially associated with the printer 102 and the general-purpose printing software 202. The OS may also activate the print function extension unit 206 at other times, such as when the OS is started. Even when a printing-related function is extended afterward, such activation enables the print function extension unit 206 to detect the extended function and add it to the print function information 203. Examples of cases in which a printing-related function is extended afterward include adding an optional device (such as a finisher) to the printer 102 at a later time.

The notification unit 209 is capable of notifying the user when an error occurs in the printer 102. For example, when a paper-out error occurs in the printer 102, the general-purpose printing software 202 detects the occurrence of the error. The OS displays, on the display 119, a message indicating the occurrence of the paper-out error, as a detection result by the general-purpose printing software 202, by using a notification function called a toast notification, which is one of the functions of the OS. When the user operates the toast notification, the notification unit 209 is invoked by the OS, and a user interface screen (UI screen) of the notification unit 209 is displayed. The user interface screen can display, for example, a detailed message regarding the paper-out error, instructions on how to load paper, and the like.

As described above, in the present embodiment, the extension application 204 can be considered to have the following four functions. The first function is a function of displaying a settings screen, and this function is performed by the print settings screen extension unit 205. The second function is a function of editing intermediate data, converting it into fax data and print data, and adding advanced settings to each of the data, and this function is performed by the intermediate data editing unit 207. The third function is a function of extending the functions that can be specified by the print data generation software, and this function is performed by the print function extension unit 206. The fourth function is a function of displaying a screen in response to the occurrence of an error in the printer 102, and this function is performed by the notification unit 209. Note that the extension application 204 is not limited to a configuration having these four functions; the extension application 204 may have a configuration with at least one of the functions, and it may also be provided with other functions.

### Example of Settings Screens

FIGS. 3A-3H are diagrams each illustrating an example of a screen displayed on the display of the printing system when the printer has a fax transmission function. FIG. 3A illustrates the fax transmission settings UI 301 displayed by the general-purpose printing software 202 and displayed on the display 119 of the host computer 101. FIGS. 3B, 3C, 3D, 3E, 3F, and 3H, each illustrate the fax transmission settings UI 211 displayed by the extension application 204 and displayed on the display 119 (display control step). As illustrated in FIG. 3A, the fax transmission settings UI 301 includes setting items 314, the button 309, and a button 310. Through the setting items 314, for example, a paper size, image quality, paper orientation for fax transmission, and other items such as a fax number of a fax recipient can be specified. By operating the button 309, the fax transmission settings UI 211 can be displayed. By operating the button 310, fax transmission can be instructed.

As illustrated in FIGS. 3B and 3E, the fax transmission settings UI 211 includes a tab 313, a tab 304, a tab 305, and a button 311. As illustrated in FIG. 3B, the tab 313 includes setting items 312. Through the setting items 312, for example, paper size, image quality, layout, and paper orientation for fax transmission can be specified. In addition, the setting items 312 allow the user to set a plurality of destinations (recipients) and to select whether to enable or disable (on/off) broadcast transmission in which the same image data is transmitted to the plurality of destinations by a single transmission instruction. The setting items 312 also allow the user to select whether to enable or disable (on/off) the use of a cover sheet including information such as sender (fax transmission source) information, and whether to enable or disable (on/off) error diffusion, which is one type of image processing for improving image quality. Furthermore, the setting items 312 allow the user to select whether to enable or disable (on/off) preview of a fax transmission image using an item 308 for simultaneous transmission and printing.

In the present embodiment, when “Cover Sheet” is selected (on), the setting items 312 may include a template selection section 321 that displays a list allowing selection of a cover sheet template to be set. In the example of FIG. 3B, either Template 1 or Template 2 can be selected in the template selection section 321. The setting items 312 may further include a setting button 331 (content setting section) for setting the content to be included in the cover sheet. In this manner, the fax transmission settings UI 211 has a function as a settings reception screen that receives a selection of a cover sheet template and also receives content settings for the selected template.

As illustrated in FIG. 3C, the template selection section 321 may be displayed as a template selection button 322. When the template selection button 322 is selected, selectable templates (Template 1, Template 2, Template 3) may be displayed as illustrated in FIG. 3D. In addition, selection of the selection button 322 may cause a dialog box 323, a template preview 326, and an OK button 324 for confirming selection of a template to be displayed. Furthermore, selection of the selection button 322 may cause a template selection window to be displayed that includes a cancel button 325 for canceling selection of a template and returning to the screen illustrated in FIG. 3C. When a template is selected by selecting the OK button 324, the display may return to the tab 313 illustrated in FIG. 3C.

As illustrated in FIG. 3E, the tab 304 includes a destination list (destination selection section) 315 that has been registered in advance in the RAM 113. One or more destinations can be selected from among a plurality of destinations included in the destination list 315. For example, when at least two destinations are selected from the destination list 315 and broadcast transmission is enabled in the tab 313, broadcast transmission is performed by operating the button 310 on the fax transmission settings UI 301.

As described above, the general-purpose printing software 202 cannot perform the function of receiving a selection setting as to whether to attach a cover sheet. Accordingly, the extension application 204 can extend the functionality to enable the selection setting as to whether to attach a cover sheet to be performed. Similarly to the selection setting as to whether to attach a cover sheet, the extension application 204 can extend the functionality so that selection of enabling/disabling broadcast transmission and the fax transmission with simultaneous printing setting can be performed. Display of the destination list also cannot be handled by the general-purpose printing software 202. Therefore, the extension application 204 may also extend the functionality to enable these settings to be performed.

As illustrated in FIG. 3I, a cover sheet template includes fields for entering information related to the sender and the recipient, such as the sender’s name, recipient’s name, fax number, company name, and department name, as well as fields for entering information such as the number of transmitted pages, an attention label, a comment, and a subject. As illustrated in FIG. 3I, examples of such fields include a field 351 for entering a label such as “Urgent” or “Confidential,” a field 352 for entering the number of pages, a field 353 for entering the subject, a field 354 for entering the sender, a field 355 for entering the recipient, and a field 356 for entering a comment. Editing of the fields in the cover sheet template can be performed by selecting the cover sheet setting button 331 illustrated in FIGS. 3B and 3C, which invokes a setting window that allows input of content to be included in the template illustrated in FIG. 3I.

As illustrated in FIG. 3F, the tab 305 includes a fax transmission history in which transmitted facsimile data are displayed in a list based on a history table. The fax transmission history includes information such as a document name, transmission date and time, number of transmitted pages, and user name. The tab 305 further includes an area 316 in which image data that has already been transmitted via fax can be displayed by selecting a job included in the fax transmission history. Additionally, the tab 305 includes a button 307 for enlarging the transmitted fax image data displayed in the area 316. As illustrated in FIG. 3H, by selecting the button 307, a window including the transmitted fax image data in an enlarged view can be displayed.

As illustrated in FIG. 3G, in response to selection of the button 311, a preview window for fax transmission data can be displayed. The preview window includes image data (composite image data) to be transmitted by fax. The preview window includes an OK button 302 for continuing the fax transmission process. The preview window also includes a transmission cancel button 303 for aborting the fax transmission process.

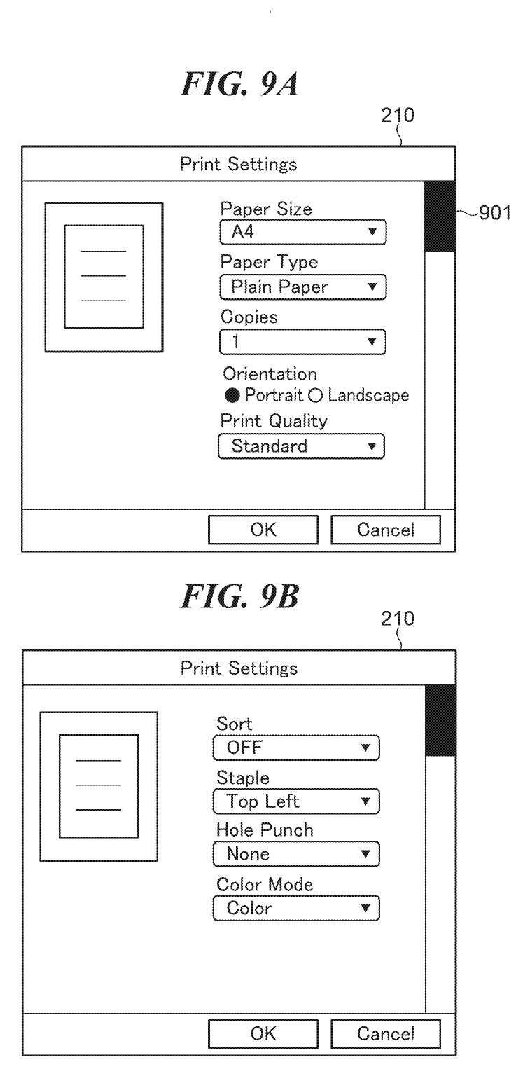

When it is determined that the capability information of the printer 102 does not include a fax function, that is, when the printer 102 is a device that does not support a fax function, the print settings screen extension unit 205 displays the print settings UI 210 illustrated in FIG. 9A. The user can operate a scroll bar 901 on the print settings UI 210 to configure other setting items that are not displayed.

When it is determined that the capability information of the printer 102 includes a fax function, that is, when the printer 102 is equipped with a fax function, the print settings screen extension unit 205 displays the fax transmission settings UI 301 on the display.

Flowchart of the Operation of the Print Function Extension Unit for Editing Print Function Information

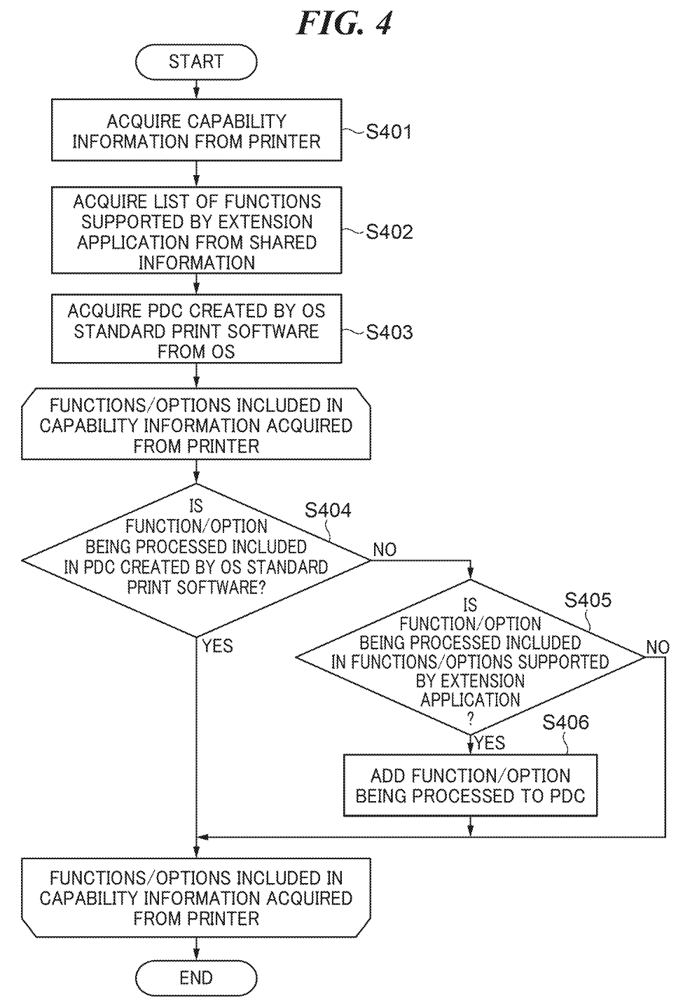

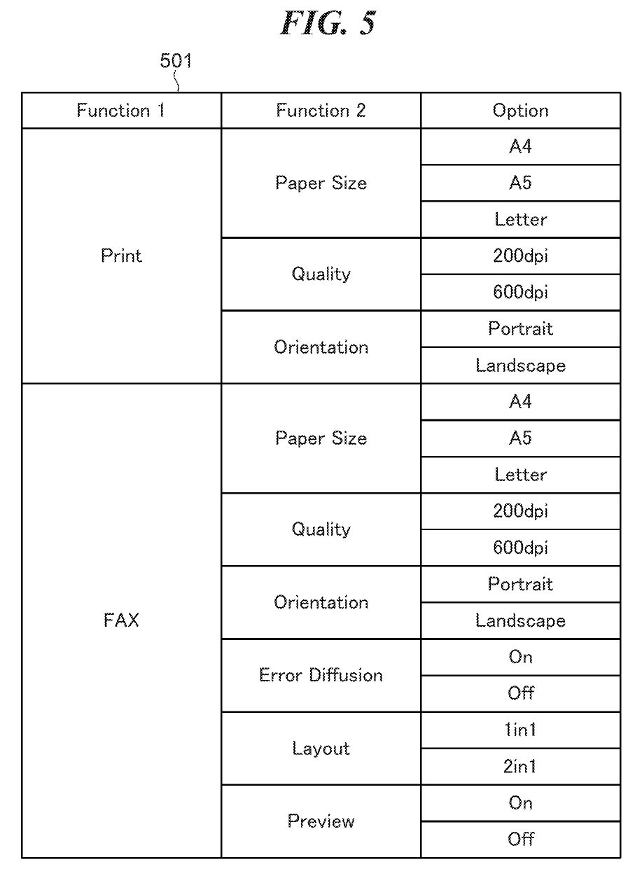

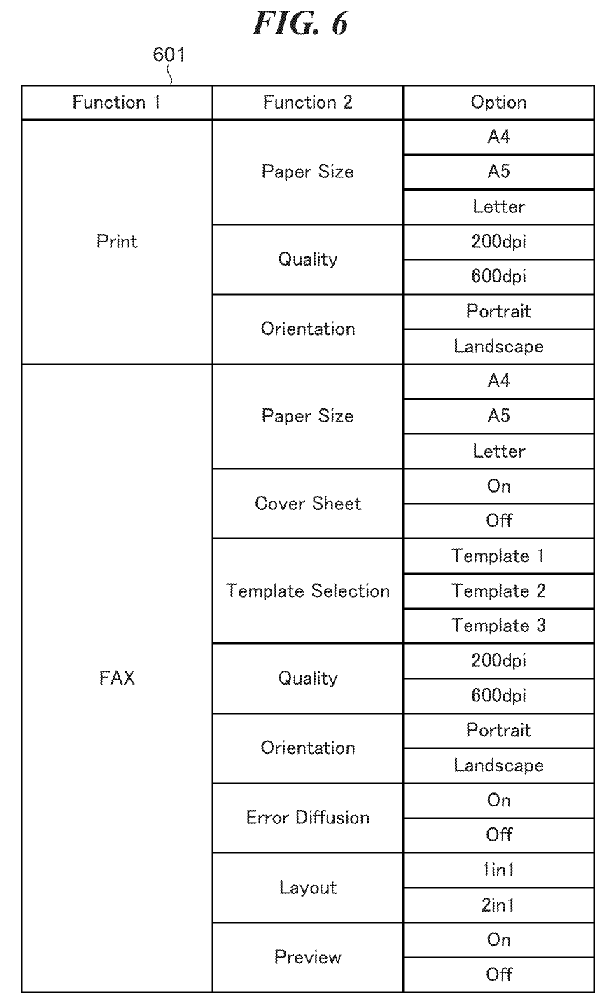

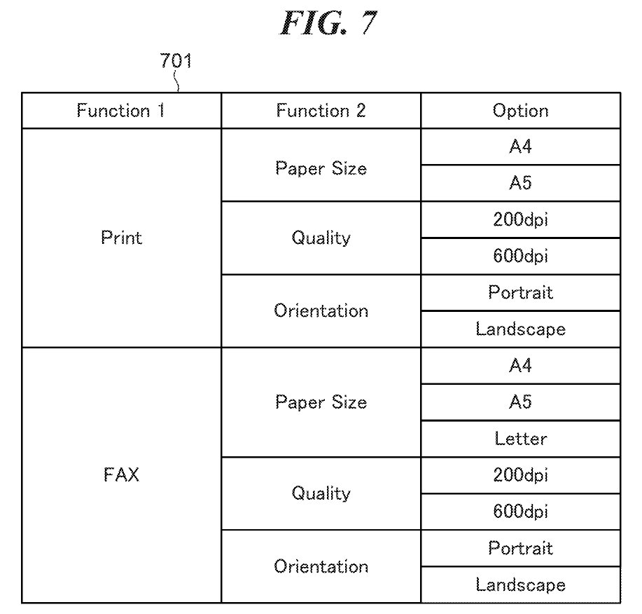

FIG. 4 is a flowchart illustrating a process in which the print function extension unit edits print function information. The computer program based on the flowchart illustrated in FIG. 4 is executed by the CPU 111, which controls the print function extension unit 206. FIG. 5 is a diagram illustrating an example of a list of capability information of the printer. FIG. 6 is a diagram illustrating an example of a list of functions supported by the extension application. FIG. 7 is a diagram illustrating an example of a list of capability information of the general-purpose printing software. As illustrated in FIG. 4, in step S401, prior to the display control step described above, the print function extension unit 206 acquires capability information from the printer 102 (acquisition step). The capability information is information related to the capabilities of the printer 102 to perform printing. In the present embodiment, the capability information corresponds to setting values included in a response obtained by issuing an IPP “Get-Printer-Attributes” request to the printer 102. The setting values relate to attribute information indicating functions that can be specified on the printer 102. Table 501 illustrated in FIG. 5 provides a list of capability information of the printer 102. The capability information includes capability information related to printing and capability information related to fax transmission. Examples of the capability information related to printing include information on paper sizes used for printing by the printer 102. Examples of the capability information related to fax transmission include information on paper sizes and information regarding the fax transmission with simultaneous printing setting.

In step S402, the print function extension unit 206 acquires, from the shared information 208, the print functions supported by the extension application 204 (acquisition step). The shared information 208 stores a list of print functions supported by the extension application 204. This list includes all print functions that can be performed by the extension application 204 and their respective setting values. The shared information 208 is stored in, for example, the external storage device (storage device) and the RAM 113 illustrated in FIG. 1. Table 601 illustrated in FIG. 6 includes, as functions supported by the extension application, capability information related to printing and capability information related to fax transmission. Examples of the capability information related to printing include information on paper sizes used for printing by the printer 102. Examples of the capability information related to fax transmission include information on paper sizes and information regarding the fax transmission with simultaneous printing setting. The functions supported by the extension application 204 may be updated through updates or the like of the extension application 204. The list of print functions includes a function for selecting a template for a fax cover sheet.

In step S403, the print function extension unit 206 acquires, from the OS, the print function information 203 created by the general-purpose printing software 202. The print function information 203 is created based on the capability information that the general-purpose printing software 202 has acquired from the printer 102 (see Table 501). The print function information 203 (PDC) created by the general-purpose printing software 202 includes, among the capability information acquired from the printer 102, only those functions that are supported by the general-purpose printing software 202. For example, Table 601 illustrated in FIG. 6 includes “Letter” as a paper size, whereas in Table 701 illustrated in FIG. 7, the general-purpose printing software 202 does not support the corresponding paper size. Accordingly, this paper size is not included in the print function information 203. In addition, Table 601 illustrated in FIG. 6 includes information related to a fax preview function, whereas in Table 701 illustrated in FIG. 7, the general-purpose printing software 202 does not support the fax preview function. Therefore, the fax preview function is not included in the print function information 203. By adding functions or options to the print function information 203, the print function extension unit 206 enables the extension application 204 to compensate for functional deficiencies of the general-purpose printing software 202. The print function extension unit 206 may also remove unnecessary functions or options from the print function information 203 created by the general-purpose printing software 202.

Steps S404, S405, and S406 are processes that are repeatedly performed for the list of functions included in the capability information acquired from the printer 102 in step S401. In the present embodiment, steps S404, S405, and S406 are repeatedly performed for all 20 options included in Table 501.

In step S404, the print function extension unit 206 determines whether the function or option currently being processed is included in the print function information 203 generated by the general-purpose printing software 202. If it is determined in step S404 that the function or option is included in the print function information 203, the process ends if the option being processed is the last one. If the option being processed is not the last one, then the next option is selected to perform step S404 again. On the other hand, if it is determined in step S404 that the function or option is not included in the print function information 203, the process proceeds to step S405. For example, in the present embodiment, Table 501 includes the paper size “A4,” and Table 701 also includes the paper size “A4.” In this case, it is determined in step S404 that the function or option currently being processed is included in the print function information 203. In contrast, Table 601 includes “template,” whereas Table 701 does not include “template.” In this case, in step S404, it is determined that the function or option currently being processed is not included in the print function information 203.

In step S405, the print function extension unit 206 determines whether the function (option) currently being processed is included in the functions (options) supported by the extension application 204. If it is determined in step S405 that the function currently being processed is included, the process proceeds to step S406. On the other hand, if it is determined in step S405 that the function currently being processed is not included, the process ends if the option being processed is the last one, in the same manner as when the determination result is “Yes” in step S404. If the option being processed is not the last one, then the next option is selected to perform step S404 again. For example, in the present embodiment, when the function currently being processed is the “fax transmission with simultaneous printing setting,” this “fax transmission with simultaneous printing setting” also exists in Table 601. Therefore, in step S405, it is determined that the function currently being processed is included.

In step S406, the print function extension unit 206 adds the function (option) currently being processed to the print function information 203. Upon completion of step S406, the process ends if the option being processed is the last one, in the same manner as when the determination result is “Yes” in step S404. If the option being processed is not the last one, then the next option is selected to perform step S404 again.

As described above, the extension application 204 can add functions (options) that are not supported by the general-purpose printing software 202, but are supported by the printer 102 and by the extension application 204, to the print function information 203. Capability information (PC) is generated based on the print function information 203 edited through this addition process. The print settings screen extension unit 205 can then generate a display screen based on this capability information, thereby supplementing the functions not supported by the general-purpose printing software 202 and displaying the fax transmission settings UI 211 (see FIGS. 3B-3H).

### Processes After the Rendering Application Receives Fax Settings

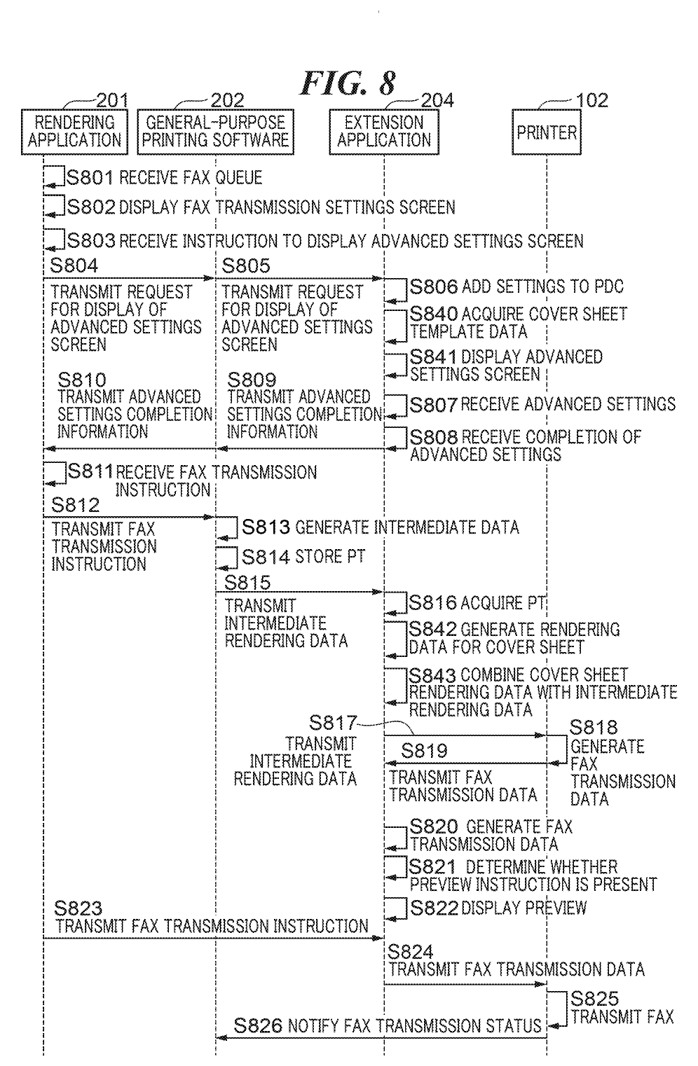

FIG. 8 is a sequence diagram illustrating processes performed among the rendering application, the general-purpose printing software, the extension application, and the printer after the rendering application receives fax settings. The operations of the rendering application, the general-purpose printing software, and the extension application are implemented by the CPU 111 of the host computer 101. The computer program for the processes is stored in the external storage device 114. The CPU 111 loads the program from the external storage device 114 into the RAM 113 and executes it. The operation of the printer 102 is implemented by the CPU (not illustrated) of the printer 102. The printing system 1000 has a software configuration as illustrated in FIG. 2B.

As illustrated in FIG. 8, in step S801, the rendering application 201 receives a fax transmission (fax queue) setting from the user. The user can instruct the rendering application 201 to perform a fax transmission setting by operating, for example, the pointing device 117 or the keyboard 118.

In step S802, the rendering application 201 displays the fax transmission settings UI 301 illustrated in FIG. 3A on the display 119.

In step S803, the rendering application 201 receives an instruction to display an advanced settings screen from the user. For example, the user can select the button 309 on the fax transmission settings UI 301 by operating the pointing device 117 or the keyboard 118 to instruct the display of an advanced settings screen.

In step S804, the rendering application 201 transmits a request for display of an advanced settings screen to the general-purpose printing software 202.

In step S805, the general-purpose printing software 202 transmits a request for display of an advanced settings screen to the extension application 204.

In step S806, the print settings screen extension unit 205 of the extension application 204 displays the fax transmission settings UI 211 illustrated in FIG. 3B in response to the request issued in step S805. As described above, a trapping setting is added to the print function information 203 (PDC) by the print function extension unit 206 and the intermediate data editing unit 207. The print settings screen extension unit 205 can display the fax transmission settings UI 211 by referring to capability information (PC) generated based on the print function information 203 to which the trapping setting has been added.

In step S840, as illustrated in FIG. 4, cover sheet templates are acquired from the printer 102 and a storage unit.

In step S841, the print settings screen extension unit 205 of the extension application 204 displays the advanced settings screen illustrated in FIGS. 3B or 3C on the host computer 101 by referring to the PC generated based on the print function information 203 to which the trapping setting has been added (described below with reference to FIG. 3B). The cover sheet template data acquired in step S840 is presented in a list format, and a list of cover sheet templates is displayed on the advanced settings screen illustrated in FIG. 3B.

In step S807, the print settings screen extension unit 205 receives detailed or advanced settings made by the user on the fax transmission settings UI 211. As an example, the following settings are assumed to have been selected on the fax transmission settings UI 211: paper size “A4”, image quality “standard”, layout “1 in 1”, broadcast transmission “on”, paper orientation “portrait”, cover sheet “on”, error diffusion “on”, and the item 308 for simultaneous transmission and printing “on”.

In step S808, the print settings screen extension unit 205 receives an operation of the button 311 under the settings set in step S807. As a result, the advanced settings are completed. For example, the user can select the button 311 by operating the pointing device 117 or the keyboard 118 to instruct the completion of the advanced settings.

In step S809, the extension application 204 transmits advanced settings completion information, indicating that the advanced settings have been completed in step S808, to the general-purpose printing software 202.

In step S810, the general-purpose printing software 202 receives the advanced settings completion information transmitted from the extension application 204 in step S809. The general-purpose printing software 202 transmits this advanced settings completion information to the rendering application 201.

In step S811, the rendering application 201 receives a fax transmission instruction from the user. For example, the user can select the button 310 on the fax transmission settings UI 301 by operating the pointing device 117 or the keyboard 118 to issue the fax transmission instruction.

In step S812, the rendering application 201 issues the fax transmission instruction received in step S811 to the general-purpose printing software 202.

In step S813, the general-purpose printing software 202 generates intermediate data based on the fax transmission instruction issued in step S812 by using an OS module.

In step S814, the general-purpose printing software 202 stores print settings information (PT) based on the fax transmission instruction issued in step S812 in the shared information 208.

In step S815, the general-purpose printing software 202 transmits rendering data (image data), which is part of the intermediate data generated in step S813, to the extension application 204.

In step S816, the intermediate data editing unit 207 of the extension application 204 acquires the print settings information stored in step S814 from the shared information 208. The intermediate data editing unit 207 also acquires the rendering data transmitted in step S815.

In step S842, the intermediate data editing unit 207 of the extension application 204 generates rendering data for the cover sheet based on the selected template. The intermediate data editing unit 207 replaces or sets each field of the template with information entered via the cover sheet setting button 331 on the screen illustrated in FIG. 3B (setting step). For example, the intermediate data editing unit 207 reflects information (content) such as a sender, a recipient, a subject, and a comment in the template, thereby replacing corresponding fields in the template with the information.

In step S843, the intermediate data editing unit 207 combines the generated cover sheet rendering data with the intermediate rendering data (composite image data generation step). As a result, the intermediate data editing unit 207 creates intermediate rendering data (composite image data) that includes the generated cover sheet rendering data. For example, the intermediate data editing unit 207 creates intermediate rendering data (composite image data) in which the generated cover sheet rendering data is set as the first page and the intermediate rendering data is set as the second and subsequent pages.

In step S817, the intermediate data editing unit 207 of the extension application 204 transmits the composited intermediate rendering data to the printer 102.

In step S818, the printer 102 generates fax transmission data using the received intermediate rendering data and the PT. The printer 102 checks the PT and determines whether only functions supported by the printer 102 have been selected. The printer 102 generates the fax transmission data only when it determines that only supported functions have been selected. If any unsupported function has been specified, the printer 102 does not generate the fax transmission data. In other words, when a function that is supported only by the extension application 204 has been specified, the printer 102 does not generate the fax transmission data.

In step S819, the printer 102 transmits the fax transmission data to the intermediate data editing unit 207 of the extension application 204. If the fax transmission data is not generated in step S818, this step is skipped.

In step S820, the intermediate data editing unit 207 of the extension application 204 generates the fax transmission data using the intermediate rendering data and the PT.

In step S821, the print settings screen extension unit 205 of the extension application 204 determines whether preview display is set to “on” in the item 308 illustrated in FIG. 3B.

In step S822, the print settings screen extension unit 205 of the extension application 204 displays the fax transmission data as illustrated in FIG. 3G. The fax transmission data includes a cover sheet generated based on the cover sheet template selected on the screen illustrated in FIG. 3B. In step S823, when the OK button 302 is selected (pressed), the process proceeds to step S824. When the transmission cancel button 303 is selected (pressed), subsequent steps are skipped and the process ends.

In step S824, the intermediate data editing unit 207 of the extension application 204 transmits the fax transmission data to the printer 102.

In step S825, the printer 102 performs fax transmission of the received fax transmission data to one or more destinations specified by the user.

In step S826, the printer 102 notifies a fax transmission status indicating whether the fax transmission process has succeeded or failed. In response to the notification of the fax transmission status, the extension application 204 stores various items of information included in the fax transmission data as a fax transmission history in the external storage device 114 (transmission history storage step). The various items of information include, for example, a document name, a transmission time, the number of transmitted pages, a recipient user name, and information about the transmitted image data.

### Print Settings Screen

FIGS. 9A and 9B are diagrams each illustrating an example of a screen displayed on the display of the printing system when the printer does not include a fax transmission function. The print settings UI 210 illustrated in FIGS. 9A and 9B is displayed on the display 119 by the print settings screen extension unit 205. As illustrated in FIG. 9A, the print settings UI 210 allows the user to specify, for example, a paper size, a paper type, the number of print copies, paper orientation, print image quality, and the like for printing. In addition, when the user operates the scroll bar 901, options such as enabling or disabling collated printing, a stapling position, whether punch holes are formed, a print mode, and the like are displayed, and the user can set these options.

### Detailed Sequence of Operations of the Extension Application

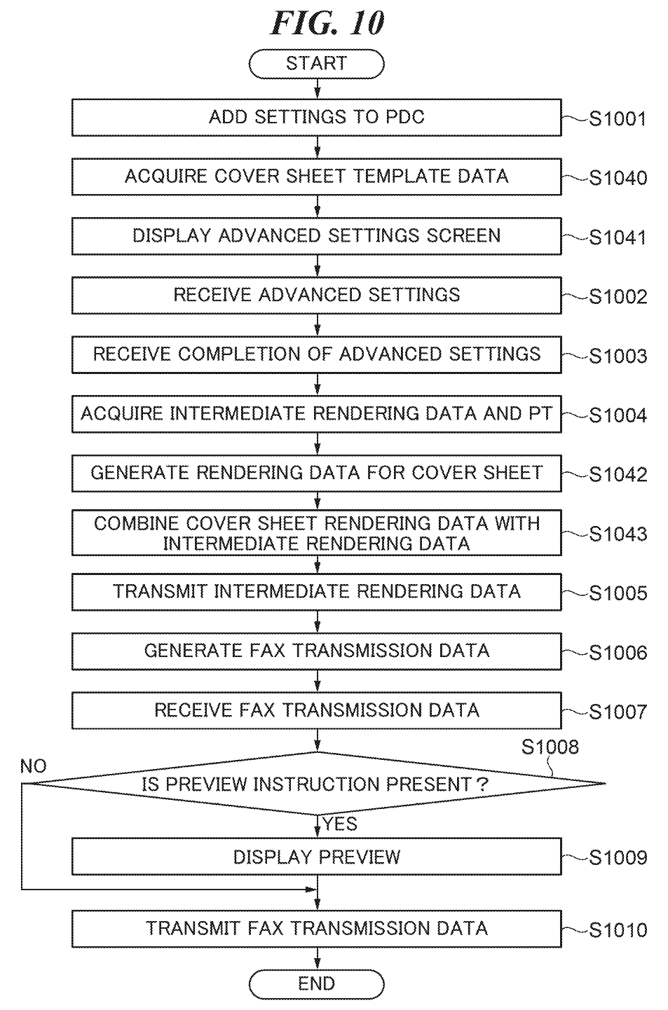

FIG. 10 is a flowchart illustrating a process performed by the extension application. The computer program based on the flowchart illustrated in FIG. 10 is executed by the CPU 111, which controls the print function extension unit 206. As illustrated in FIG. 10, in step S1001, upon receiving a request to display an advanced settings screen from the general-purpose printing software 202, the print function extension unit 206 adds various fax-related settings to the PDC, as described with reference to FIG. 4. In step S1040, the print function extension unit 206 acquires cover sheet template data from the external storage device or shared information (the external storage device 114, the RAM 113).

In step S1041, the print function extension unit 206 displays the advanced settings screen illustrated in FIG. 3B.

In step S1002, the print function extension unit 206 receives advanced settings.

In step S1003, the print function extension unit 206 receives completion of the advanced settings. The user can select the button 311 by operating the pointing device 117 or the keyboard 118 to instruct the completion of the advanced settings.

In step S1004, the print function extension unit 206 acquires intermediate rendering data and PT from the general-purpose printing software 202.

In step S1042, the print function extension unit 206 generates rendering data for the selected cover sheet.

In step S1043, the print function extension unit 206 combines the cover sheet rendering data with the intermediate rendering data.

In step S1005, the print function extension unit 206 transmits the acquired intermediate rendering data to the printer 102.

In step S1006, the printer 102 generates fax transmission data.

In step S1007, the print function extension unit 206 receives the fax transmission data generated by the printer 102.

In step S1008, the print function extension unit 206 determines whether preview display is set to “on” in the item 308 for simultaneous transmission and printing illustrated in FIG. 3B. If it is determined that preview display is set to “on”, the process proceeds to step S1009. If it is determined that preview display is set to “off”, the process proceeds to step S1010.

In step S1009, the print function extension unit 206 displays the fax transmission data as illustrated in FIG. 3G. The fax transmission data includes a cover sheet generated based on the cover sheet template selected on the screen illustrated in FIG. 3B.

In step S1010, the print function extension unit 206 transmits the fax transmission data to the printer 102.

As described above, according to the present embodiment, the print settings screen extension unit 205 of the extension application 204 modifies the PDC 203 based on the capability information of the general-purpose printing software 202, the extension application 204, and the printer 102. In addition, when a request for an advanced settings screen is received from the user, the print settings screen extension unit 205 displays the settings screen based on the PC generated from the PDC 203, thereby allowing the user to select a template for a fax cover sheet. Through the series of processes described above, it becomes possible to utilize the function of allowing the user to select a template for a fax cover sheet.

In the present embodiment, the extension application 204 generates print data based on intermediate data generated by the general-purpose printing software 202. However, the extension application 204 itself may generate the intermediate data.

In the present embodiment, the extension application 204 generates fax transmission data. However, the general-purpose printing software may generate the fax transmission data.

### Second Embodiment

In the first embodiment, a method has been described in which cover sheet templates are acquired from the external storage device 114 and displayed on the advanced settings screen to allow the user to select one. However, some templates may be stored in the printer 102, while others may be downloaded by the user from a vendor’s website or created using editing software provided by the vendor. The extension application 204 receives templates from their respective storage locations and displays them; however, templates provided by the same vendor may include identical ones. If the same template is displayed multiple times, it becomes difficult for the user to select a template. Accordingly, in the second embodiment, when there are duplicate templates, only one of them is displayed. As a result, the list becomes easier to view, and the user can more easily select a template. The following description focuses only on differences from the first embodiment.

As an example, a case will be described in which the external storage device 114 and the printer 102 each store the same template. The external storage device 114 and the printer 102 are examples of a storage device that stores templates. Examples of the storage device that stores templates may also include the RAM 113 of the host computer 101, a network drive (not illustrated) connected to the host computer 101, and the like.

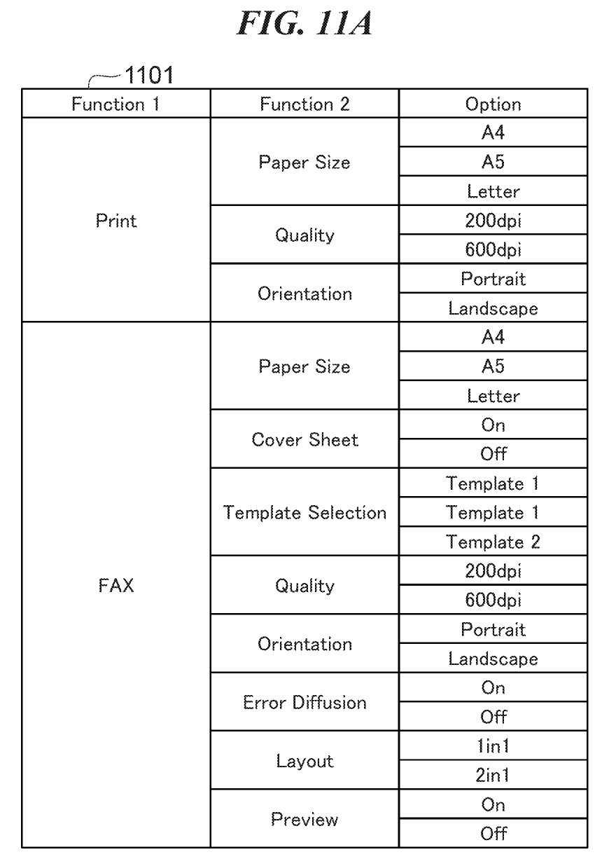

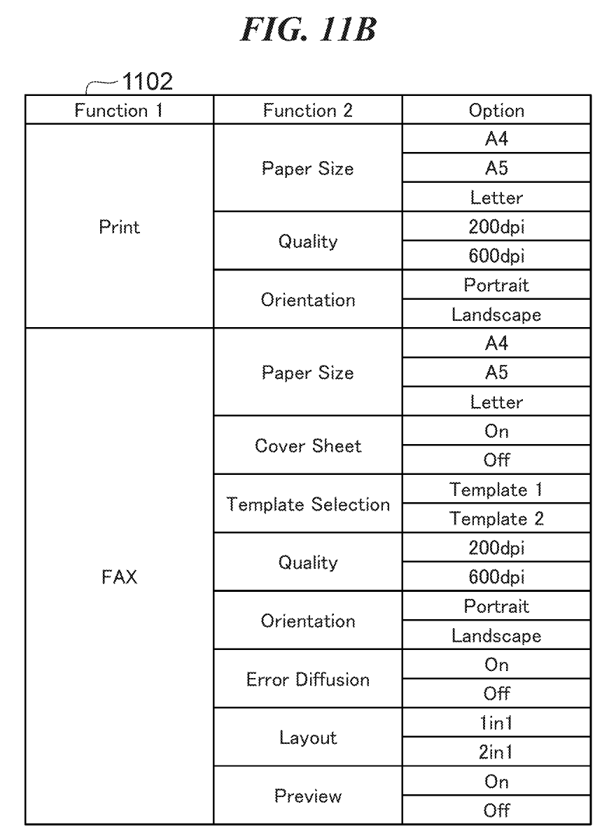

Table 1101 illustrated in FIG. 11A represents capability information generated by the extension application 204 using the capability information stored in the external storage device 114 and the capability information stored in the printer 102. Since both the external storage device 114 and the printer 102 store a template having the same name “Template 1”, Table 1101 includes duplicate entries of “Template 1” under “Template Selection.”

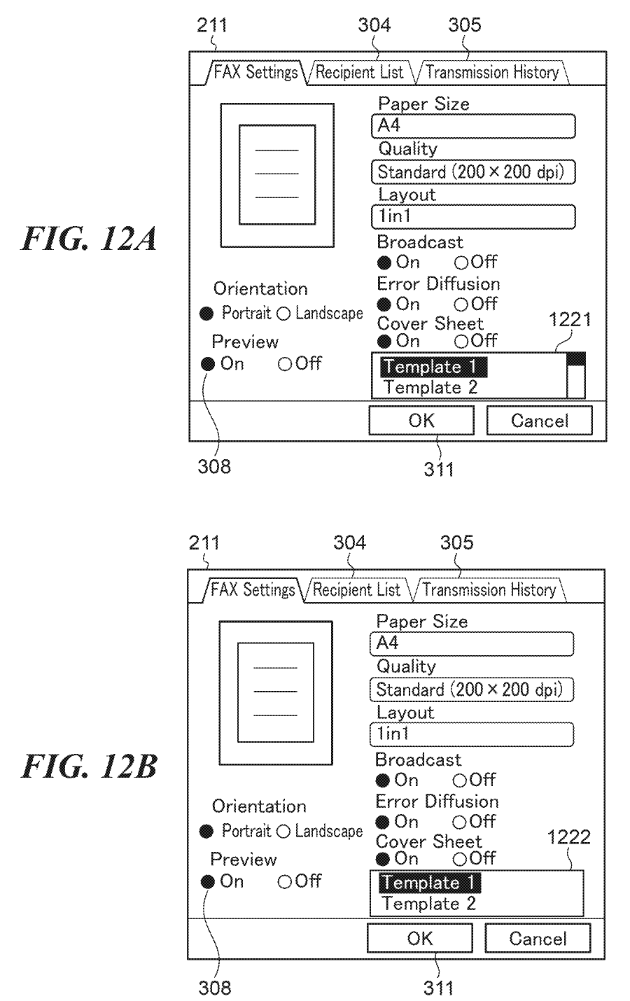

FIG. 12A illustrates an advanced settings screen (template selection screen) displayed based on capability information (PC) generated from PDC generated based on the capability information indicated in Table 1101. In a template selection section 1221, “Template 1” is displayed twice because both of the duplicated “Template 1” entries present in the capability information are displayed.

Table 1102 illustrated in FIG. 11B represents capability information generated by the extension application 204 in the present embodiment under the same conditions as in Table 1101. In Table 1102, the extension application 204 limits the option “Template 1” under “Template Selection” of Function 2 to a single entry. In this manner, the extension application 204 generates capability information in which duplicated templates are consolidated into a single entry. FIG. 12B illustrates an advanced settings screen displayed based on capability information (PC) generated from PDC generated based on the capability information indicated in Table 1102. In a template selection section 1222, only one “Template 1” is displayed, since only one “Template 1” entry is present in the capability information.

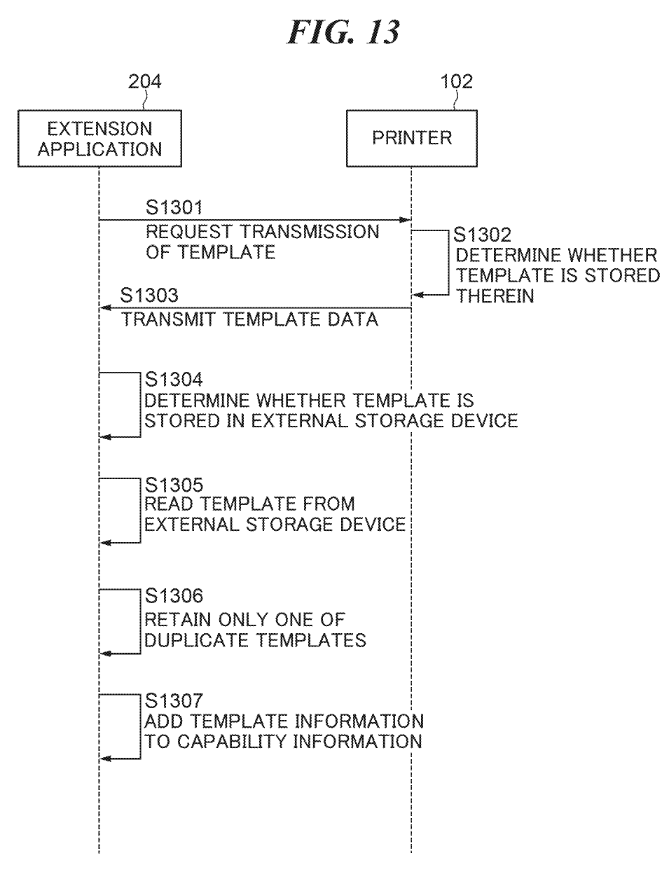

FIG. 13 is a sequence diagram illustrating an example of details of step S840 illustrated in FIG. 8 according to the present embodiment.

In step S1301, the extension application 204 requests a template from the printer 102. Specifically, the extension application 204 requests transmission of a template stored in the printer 102.

In step S1302, the printer 102 determines whether a cover sheet template is stored therein. For example, the printer 102 determines whether a cover sheet template is stored based on its capability information.

In step S1303, when the printer 102 stores a template, the printer 102 transmits the stored template to the extension application 204.

In step S1304, the extension application 204 determines whether a template is stored in the external storage device 114.

In step S1305, when it is determined in S1304 that a template is stored in the external storage device 114, the extension application 204 reads the template from the external storage device 114.

In step S1306, when there are duplicate templates among the templates acquired in steps S1303 and S1305, the extension application 204 retains only one of them.

Next, in step S1307, the extension application 204 adds the acquired template information to the capability information of the extension application 204.

Through the processing as described above, when the external storage device 114 and the printer 102 store duplicate templates, only one of those templates is displayed. This makes the template list easier to view and easier for the user to select a template. In the present embodiment, template data is acquired from the external storage device 114 and the printer 102; however, templates stored in shared information or held by template editing software may instead be acquired. In addition, templates stored in the RAM 113 may also be read and acquired.

### Third Embodiment

In the first embodiment, a method has been described in which cover sheet templates acquired from the external storage device 114 are displayed on a template selection screen to allow the user to select one. A template includes fields for entering information relating to a sender and a recipient, such as sender/recipient names, fax numbers, company names, and department names, as well as information (content) such as the number of transmitted pages, an attention label, a comment, and a subject. These fields are replaced with information specified by the driver at the time of fax transmission. As described above, the screen illustrated in FIG. 3B includes the setting button 331 (content setting section) for specifying information to be entered into the fields of the template selected on the screen illustrated in FIGS. 3B or 3D. When the setting button 331 is pressed, a cover sheet setting window (not illustrated) is displayed, and various types of information can be entered in the cover sheet setting window. However, it is cumbersome for the user to manually enter the sender and recipient information using a keyboard each time they send a fax. Therefore, in the third embodiment, information to be entered in the fields can be automatically input. In the following, a method for automatically entering recipient information will be described.

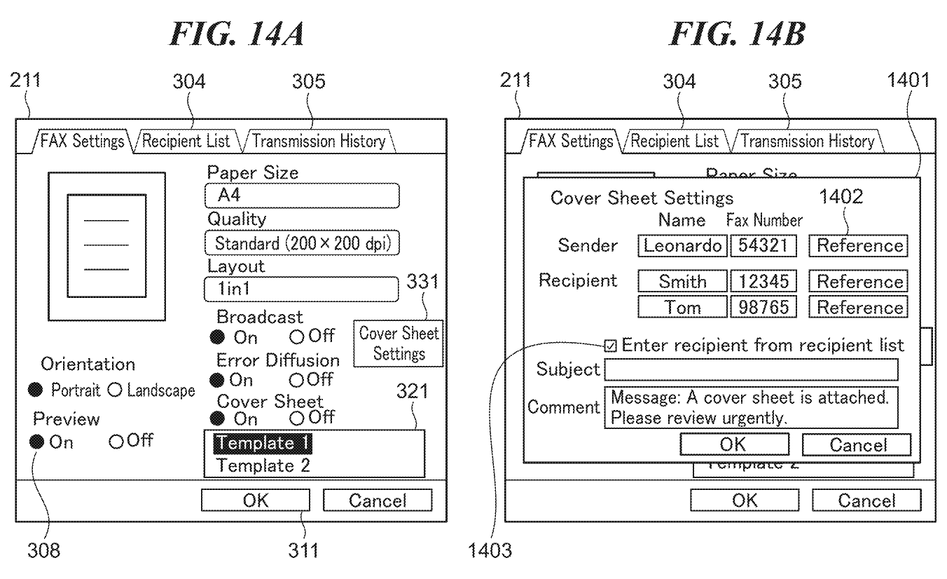

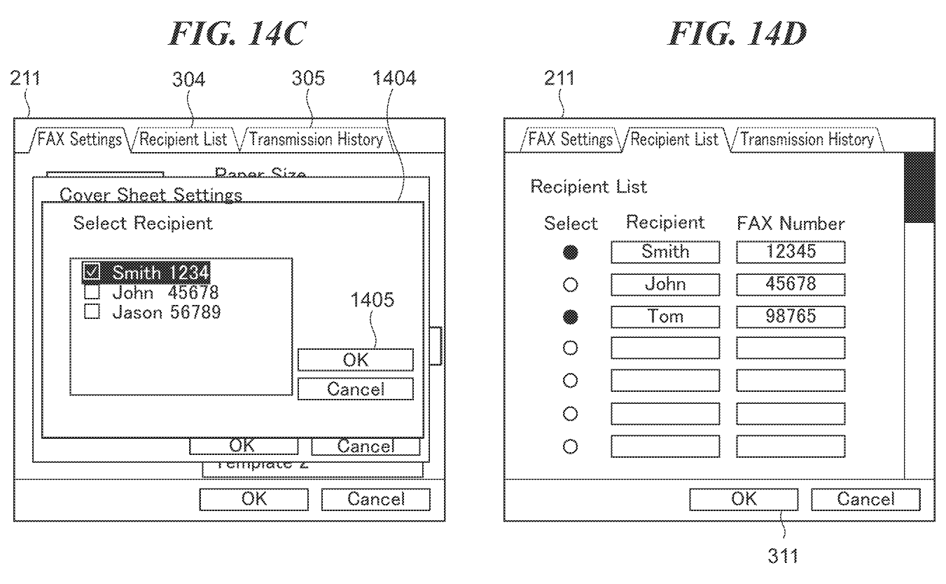

FIG. 14B illustrates a screen including a window 1401 that is displayed when the setting button 331 is pressed on the settings reception screen illustrated in FIG. 14A. The window 1401 allows the user to configure cover sheet settings. The window 1401 displays, for example, dialog boxes in which the sender’s name and fax number, the recipient’s name and fax number, a subject, and a comment can be directly entered. In addition, the window 1401 may include dialog boxes for specifying a company name, a department name, the number of transmitted pages, an attention label, and the like. Although the window 1401 includes dialog boxes for entering recipient names and fax numbers for only two recipients, there may be more such dialog boxes, and the number of dialog boxes may correspond to the number of recipients that can be specified in a destination list illustrated in FIG. 14D.

### Method for Referencing the Destination from an External Device

The window 1401 includes a reference button 1402 (reference selection section) for referencing recipient information from an external device. For example, the printer 102 has an address book that includes destinations. When the reference button 1402 is pressed, the extension application 204 acquires address book information from the printer 102. Alternatively, the external storage device 114 may store an address book, and the extension application 204 may acquire the address book stored in the external storage device 114. Upon acquiring the address book information, the extension application 204 displays the acquired destination information in a list, as indicated in a window 1404 illustrated in FIG. 14C. The window 1404 allows the user to select, from the list, a name and a fax number to be included on the cover sheet. When there are a plurality of entry fields for recipient names and fax numbers, a plurality of destinations may be selected. When an OK button 1405 is pressed, the extension application 204 closes the window 1404 and reflects the selected name and fax number in the dialog boxes of the window 1401.

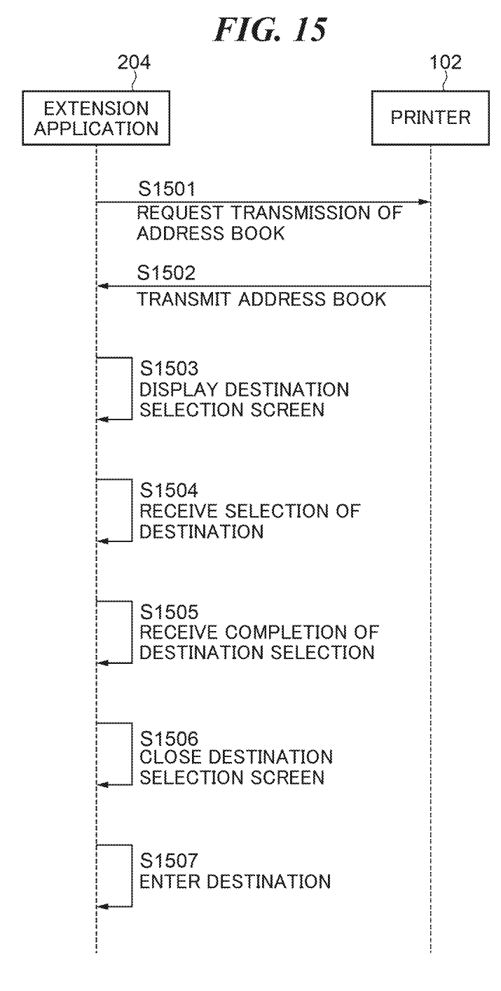

FIG. 15 is a sequence diagram illustrating details of a destination selection process that is started when the reference button 1402 is pressed in the window 1401 for cover sheet settings.

In step S1501, the extension application 204 requests the printer 102 to transmit the address book.

In step S1502, the printer 102 transmits the address book.

In step S1503, the extension application 204 displays the window 1404 for destination selection. In the window 1404, destination information based on the address book acquired from the printer 102 in step S1502 is displayed in a list (see FIG. 14C).

In step S1504, the extension application 204 receives a selection of a destination made by the user.

In step S1505, the extension application 204 receives a user operation on the OK button 1405 indicating completion of the destination selection.

In step S1506, the extension application 204 closes the window 1404 in response to the completion of the destination selection by the user.

In step S1507, the extension application 204 enters the name and fax number of the destination selected by the user into dialog boxes for the recipient’s name and fax number in the window 1401.

### Method for Acquiring a Destination from the Destination List

The window 1401 also includes a UI 1403 (a dialog box) for specifying that a destination from the destination list be entered. When this option is selected, the extension application 204 automatically fills the recipient name and fax number fields in the window 1401 with the destination name and fax number that have been entered in the destination list of the tab 304 previously registered in the RAM 113. If the window 1401 has a plurality of fields for entering recipient names and fax numbers, the extension application 204 may enter all destinations specified in the destination list into the window 1401.

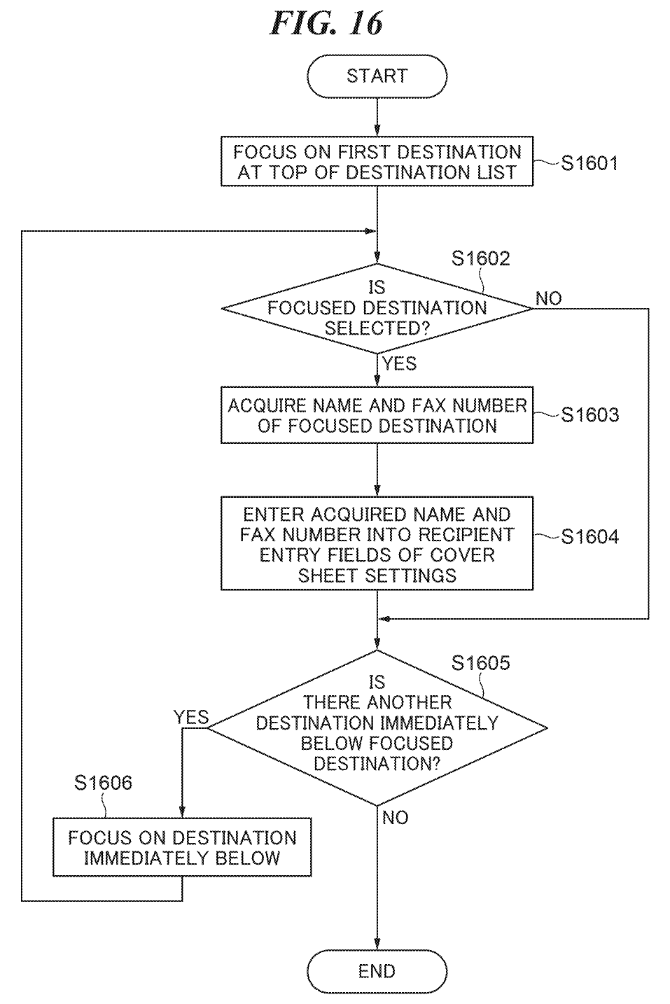

FIG. 16 is a flowchart illustrating in detail a process for entering a destination from the destination list. The process starts when the UI 1403 for specifying entry of a destination from the destination list is operated.

In step S1601, the print function extension unit 206 reads the destination list from the RAM 113. A destination is selected from the read destination list (see FIG. 14C). The print function extension unit 206 focuses on the first destination (from the top) among the destinations entered in the destination list.

In step S1602, the print function extension unit 206 determines whether the destination focused on in step S1601 is selected as a recipient. If it is determined that the destination is selected as a recipient, the process proceeds to step S1603. Otherwise, the process proceeds to step S1605.

In step S1603, the print function extension unit 206 acquires the destination name and fax number of the destination focused on in step S1601.

In step S1604, the print function extension unit 206 enters the destination name and fax number acquired in step S1603 into the recipient entry fields (dialog boxes) of the cover sheet settings.

In step S1605, the print function extension unit 206 determines whether there is another destination immediately below the destination focused on in step S1601. If it is determined that there is another destination, the process proceeds to step S1606, in which the destination to be focused on is changed to the next one below. The process is repeated until all destinations have been focused on. On the other hand, if it is determined that there is no such destination, the process ends.

As described above, when the reference button 1402 is pressed, the extension application 204 acquires address book information stored in the printer 102. Thereafter, the extension application 204 presents the user with a list to allow the user to select therefrom a name and a fax number to be included on the cover sheet, and then reflects the selected name and fax number in the designated fields of the window 1401.

In addition, when a UI for specifying entry of a destination from the destination list is selected, the extension application 204 automatically fills the recipient name and fax number fields in the window 1401 with the destination name and fax number that have been entered in the destination list of the tab 304.

In this manner, since recipient information is entered automatically, it is possible to eliminate the need for the user to manually enter such information using a keyboard each time they send a fax.

### Fourth Embodiment

In the first to third embodiments, a function for selecting a cover sheet template has been described. However, the user may edit a selected cover sheet template by, for example, changing the positions of fields or adding necessary fields or deleting unnecessary fields according to the usage scenario. In addition, the user may save such an edited cover sheet as a new template. In such cases, it is necessary to separately launch dedicated cover sheet editing software, which is cumbersome. Accordingly, in the fourth embodiment, the extension application 204 operates so as to be able to launch the editing software.

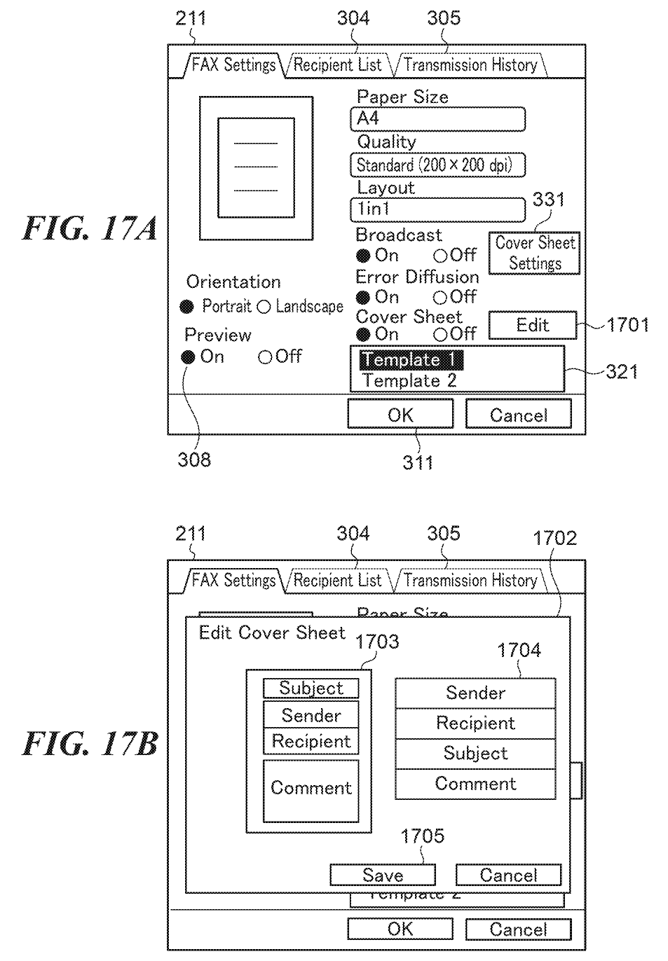

FIG. 17A illustrates an advanced fax settings screen provided with a cover sheet edit button 1701 (editing section) for launching cover sheet editing software. When the cover sheet edit button 1701 is pressed by the user in a state in which a template is selected in the cover sheet template selection section 321, the extension application 204 launches the cover sheet editing software. When the cover sheet edit button 1701 is pressed without a template being selected, the extension application 204 may create a new template. The cover sheet editing software may be incorporated in the extension application 204, or alternatively, the extension application 204 may launch external software designed to cooperate with the extension application 204. A window 1702 illustrated in FIG. 17B is an example of a screen (editing screen) displayed by the cover sheet editing software. The extension application 204 displays a cover sheet template being edited in a view 1703. Objects 1704 represent details of items to be arranged in the template. In addition to the recipient, sender, subject, and comment illustrated as the objects 1704, objects such as a company name, a department name, the number of transmitted pages, and an attention label may also be provided. The extension application 204 allows the user to select one of the objects 1704 on the screen and place the selected object on the view 1703, or to move an object already placed on the view 1703 to change its position. When a save button 1705 is pressed, the extension application 204 saves the edited template. The extension application 204 stores the edited template in, for example, the external storage device 114 or the printer 102 as a storage destination. After storing the template, the extension application 204 displays the advanced fax settings screen illustrated in FIG. 17A. Accordingly, the extension application 204 enables the user to select the stored template in the template selection section 321 on the advanced settings screen, thereby allowing use of the edited template.

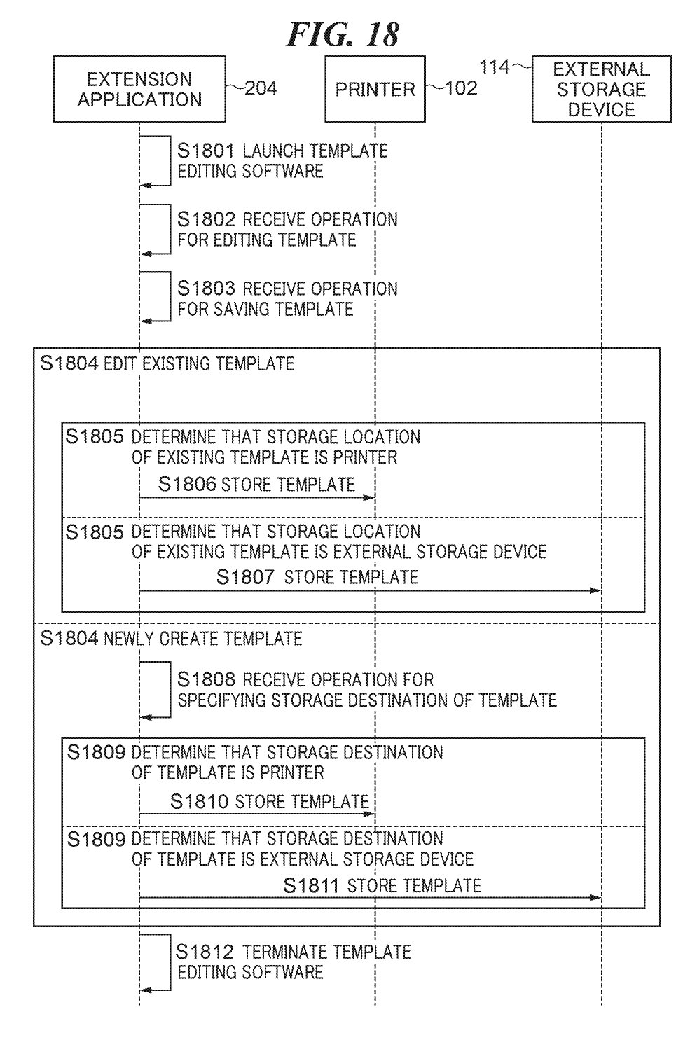

FIG. 18 is a sequence diagram for explaining in detail a process of editing a cover sheet template and selecting it. This sequence starts when the cover sheet edit button 1701 illustrated in FIG. 17A is pressed.

In step S1801, the extension application 204 launches the template editing software.

In step S1802, the extension application 204 receives an operation for editing a template.

In step S1803, the extension application 204 receives an operation for saving the template (template storage step).

In step S1804, the extension application 204 determines whether the edited template is an existing template or a newly created template.

If it is determined in step S1804 that the edited template is an existing template, then in step S1805, the extension application 204 determines whether the storage location of the existing template before editing is the printer 102 or the external storage device 114.

If it is determined in step S1805 that the storage location of the existing template is the printer 102, then in step S1806, the extension application 204 stores the template in the printer 102. If it is determined in step S1805 that the storage location of the existing template is the external storage device 114, then in step S1807, the extension application 204 stores the template in the external storage device 114.

If it is determined in step S1804 that the edited template is a newly created template, then in step S1808, the extension application 204 receives an operation for specifying a storage destination of the template.

Next, in step S1809, the extension application 204 determines whether the storage destination of the template specified in step S1808 is the printer 102 or the external storage device 114.

If it is determined in step S1809 that the storage destination of the template is the printer 102, then in step S1810, the extension application 204 stores the template in the printer 102. If it is determined in step S1809 that the storage destination of the template is the external storage device 114, then in step S1811, the extension application 204 stores the template in the external storage device 114.

After any of step S1806, S1807, S1810, or S1811 is completed, in step S1812, the extension application 204 terminates the template editing software.

As described above, when the cover sheet edit button 1701 is pressed by the user, the extension application 204 launches the editing software. This eliminates the need to launch dedicated cover sheet editing software separately, thereby reducing the time and effort required for the user to edit a cover sheet template.

According to the embodiments described above, it is possible to provide technology for configuring settings related to a cover sheet in implementing a fax function in an image processing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A non-transitory computer-readable storage medium storing a computer program that supports a standard driver provided by a provider of an operating system and that causes a computer to perform:
a display control step of displaying a settings reception screen including a template selection section configured to receive a selection of a template related to a cover sheet to be attached to image data output from the standard driver.

2. The non-transitory computer-readable storage medium according to claim 1, wherein the computer program further causes the computer to perform:
an acquisition step of acquiring, from a storage device, capability information related to capabilities of an image processing apparatus that transmits the image data, prior to the display control step; and
a determination step of determining whether the capability information acquired in the acquisition step includes information related to a selectable template.

3. The non-transitory computer-readable storage medium according to claim 2, wherein:
the computer program further causes the computer to perform the display control step when it is determined in the determination step that the capability information includes information related to a selectable template; and
the computer program further causes the computer not to perform the display control step when it is determined that the capability information does not include information related to a selectable template.

4. The non-transitory computer-readable storage medium according to claim 3, wherein the computer program further causes the computer to perform an instruction step of instructing the image processing apparatus to perform transmission of the image data including the template, based on the selection of the template on the settings reception screen.

5. The non-transitory computer-readable storage medium according to claim 4, wherein
the computer program further causes the computer to perform, after the display control step and before the instruction step, a setting step of setting content to be included in the template,
the settings reception screen includes a content setting section configured to allow setting of the content to be included in the template, and
the setting step is performed in response to selection of the content setting section.

6. The non-transitory computer-readable storage medium according to claim 5, wherein
the computer program further causes the computer to perform, after the display control step and before the instruction step, an editing step of editing a layout of the template,
the settings reception screen includes an editing section configured to allow editing of the template, and
the editing step is performed in response to selection of the editing section.

7. The non-transitory computer-readable storage medium according to claim 5, wherein
the setting step includes displaying, on the settings reception screen, a reference selection section configured to allow referencing of one or more destinations to be set in the template, in response to selection of the content setting section,
the acquisition step includes acquiring, from the image processing apparatus, one or more destination addresses stored in the image processing apparatus, in response to selection of the reference selection section,
the setting step includes displaying, on the settings reception screen, the acquired destination addresses, and
the setting step includes reflecting, in the template, an address selected from the displayed destination addresses.

8. The non-transitory computer-readable storage medium according to claim 5, wherein
the setting step includes displaying, on the settings reception screen, a dialog box for directly entering the content into the template, in response to selection of the content setting section, and
the setting step includes reflecting, in the template, the content entered in the dialog box.

9. The non-transitory computer-readable storage medium according to claim 6, wherein the editing step includes displaying, on the settings reception screen, an editing screen for editing the template, in response to selection of the editing section.

10. The non-transitory computer-readable storage medium according to claim 9, wherein
the editing screen for editing the selected template is displayed in the editing step when the template and the editing section are selected, and
the editing screen for newly creating a template is displayed in the editing step when only the editing section is selected.

11. The non-transitory computer-readable storage medium according to claim 10, wherein
the computer program further causes the computer to perform a template storage step of storing the edited or newly created template,
the editing step includes reflecting input made on the editing screen in the template, and
the template storage step includes storing, in the storage device, the template in which the input has been reflected.

12. The non-transitory computer-readable storage medium according to claim 11, wherein, when the template has been edited, the template storage step includes storing the edited template in the storage device that stores the template before editing.

13. The non-transitory computer-readable storage medium according to claim 11, wherein, when the template has been newly created,
the editing step includes receiving a designation of a storage destination for the newly created template, and
the template storage step includes storing the newly created template in the designated storage destination.

14. The non-transitory computer-readable storage medium according to claim 2, wherein the display control step includes displaying, on the settings reception screen, a plurality of templates having the same name as a single template when the capability information includes the plurality of templates having the same name.

15. The non-transitory computer-readable storage medium according to claim 7, wherein
the computer program further causes the computer to perform a composite image data generation step of generating composite image data obtained by combining the image data and the selected template between the display control step and the instruction step, and
the instruction step includes transmitting the generated composite image data to the image processing apparatus.

16. The non-transitory computer-readable storage medium according to claim 8, wherein
the computer program further causes the computer to perform a composite image data generation step of generating composite image data obtained by combining the image data and the selected template between the display control step and the instruction step, and
the instruction step includes transmitting the generated composite image data to the image processing apparatus.

17. The non-transitory computer-readable storage medium according to claim 15, wherein the computer program further causes the computer to perform a transmission history storage step of storing, in the storage device, information on the composite image data and a transmission time in response to execution of the instruction step.

18. The non-transitory computer-readable storage medium according to claim 16, wherein the computer program further causes the computer to perform a transmission history storage step of storing, in the storage device, information on the composite image data and a transmission time in response to execution of the instruction step.

19. A control method for controlling support of a standard driver provided by a provider of an operating system, the control method comprising:
displaying a settings reception screen including a template selection section configured to receive a selection of a template related to a cover sheet to be attached to image data output from the standard driver.

20. An information processing apparatus, comprising:
a standard driver provided by a provider of an operating system;
one or more processors;
at least one memory storing a computer program that supports the standard driver, the computer program comprising instructions that, when executed by the one or more processors, cause the one or more processors to:
display a settings reception screen including a template selection section configured to receive a selection of a template related to a cover sheet to be attached to image data output from the standard driver.
